(19) United States
(12) Patent Application Publication
(10) Pub. No.: US 2024/0096047 A1
(43) Pub. Date: Mar. 21, 2024

(54) SYSTEMS AND METHODS FOR AN ADAPTIVE AND REGION-SCALE PROPOSING MECHANISM FOR OBJECT RECOGNITION SYSTEMS

(71) Applicant: Arizona Board of Regents on Behalf of Arizona State University, Tempe, AZ (US)

(72) Inventors: Mohammad Farhadi, Tempe, AZ (US); Yezhou Yang, Scottsdale, AZ (US); Rahul Santhosh Kumar Varma, Tempe, AZ (US)

(73) Assignee: Arizona Board of Regents on Behalf of Arizona State University, Tempe, AZ (US)

(21) Appl. No.: 18/460,053

(22) Filed: Sep. 1, 2023

Related U.S. Application Data
(60) Provisional application No. 63/374,331, filed on Sep. 1, 2022.

(51) Int. Cl. G06V 10/25; G06V 10/82; G06V 20/54

(52) U.S. Cl. CPC G06V 10/25; G06V 10/82; G06V 20/54

(57) ABSTRACT

Based on traffic images characteristics, a general pre-processing system and method reduces input size of neural network object recognition models to focus on necessary regions. The system includes a light neural network (binary or low precision; based on configuration) to detect target regions for further processing and applies a deeper model to those specific regions. The present disclosure provides experimentation results on various types of methods, such as conventional convolutional neural networks, transformers, and adaptive models, to show the scalability of the system.

### CROSS REFERENCE TO RELATED APPLICATIONS

This is a non-provisional application that claims benefit to U.S. Provisional Application Ser. No. 63/374,331, filed on Sep. 1, 2022, which is herein incorporated by reference in its entirety.

### GOVERNMENT SUPPORT

This invention was made with government support under grant nos. 1652132 and 2054807 awarded by the National Science Foundation. The government has certain rights in the invention.

### FIELD

The present disclosure generally relates to object recognition systems, and in particular, to a system and associated method for object recognition with reduced computational cost.

### BACKGROUND

In recent years, there has been significant success in computer vision with applications such as object detection and instance segmentation. Although research in this field has been progressing rapidly, there is still a considerable gap between research and practical deployment. The vision-based intersection management (vIM) of connected autonomous vehicles (CAVs) is one of the emerging applications which will become an essential part of cities. A study conducted by American Automobile Association (AAA) shows more than two people are killed every day in the U.S. due to accidents caused by red-light runners.

We face two main challenges in vIM: 1) The processing unit needs to be at the location; using cloud computing is not feasible as it requires an extensive network infrastructure that can support the required bandwidth for the cameras. Furthermore, network delays increase response time. 2) Existing DNNs are energy hungry, affecting deployment practicality for battery-powered or energy-harvested systems. Object recognition is the most energy and computational demanding module in vIM. This problem aggravated as vIM needs to be accurate and agile in an embedded environment with limited resources.

A new set of recognition models have been proposed to address the high computation cost of neural networks using new architectures or compressing models. These approaches consider all image regions equally important and apply a model to all image pixels. Dynamic neural networks try to solve this issue by adopting gating mechanisms to control the depth of the model; or selecting regions that are important and process those independently. Although these approaches showed promising results, their applicability is limited to residual neural networks.

In addition, new methods have been proposed for video object recognition which consider the temporal relationships between frames to reduce the computation cost and inference time. These models are inspired by the human visual system, which relies on contextual cues and memory to supplement their understanding of the environment. These models use a light model for the inference time and adapt it to the environment using online knowledge distillation from a deeper model. Although this set of object recognition models can reduce the computation cost and thus the inference time, their predictive performance relies on deep features extraction on a few keyframes. The keyframe selection highly depends on how often significant scene change happens and the number of emerging new objects. Thus, the keyframe mechanism becomes the impeding factor preventing model deployment on embedded devices. Furthermore, the processing time of selecting and extracting features from the keyframes can degrade system response time, switching from one scene to another as a deeper model is applied to the whole frame.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a photograph showing an experimental setup of a system for object recognition positioned over a traffic intersection;

FIG. 2 is a simplified diagram showing the system of FIG. 1 including an ROI proposal module and an ROI processing module;

FIG. 3 is a simplified diagram showing the system of FIG. 2 modified in a knowledge distillation pipeline;

FIG. 4 is an image showing sequential removal of regions of a frame of interest to reduce computational cost of object recognition;

FIG. 5 is a schematic diagram showing a device for implementation of the system of FIGS. 1 and 2;

FIG. 6A is a graphical representation showing results of segmentation metrics of the present system on the instance segmentation classes on the Cityscapes dataset;

FIG. 6B is a graphical representation showing results of the mAP statistics for object detection and segmentation on the COCO dataset;

FIG. 7 is an image showing an example of a fast-moving object which can be missed by object detectors due to their inference time;

FIG. 8A is a graphical representation showing execution time and accuracy of the system of FIGS. 2 and 3 with online knowledge distillation and without it;

FIG. 8B is a graphical representation showing results of mAP statistics calculated on the UA-DETRAC dataset with models constrained to process 25 fps;

FIG. 9 is a process flow chart showing an example method for object recognition according to the system of FIGS. 1 and 2; and

FIG. 10 is a simplified diagram showing an example computing system for implementation of the system of FIGS. 1 and 2.

Corresponding reference characters indicate corresponding elements among the view of the drawings. The headings used in the figures do not limit the scope of the claims.

### DETAILED DESCRIPTION

### 1. Introduction

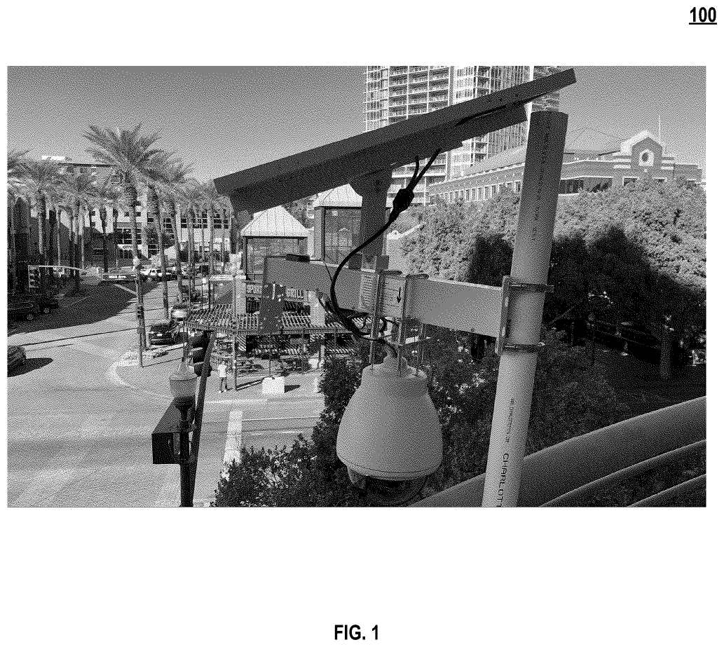

Various embodiments of systems and associated methods of a system (hereinafter, system 100 shown in FIGS. 1-5) for vision-based intersection management are disclosed herein. The system 100 provides a general pre-processing method to reduce an input size of neural network-based models to allocate resources such that they focus on necessary regions. The system 100 includes a light neural network (binary or low precision; based on configuration) to detect target regions for further processing. The system 100 applies a deeper model to the target regions.

In this work, two main characteristics of vision-based intersection management (vIM) are studied that help the system 100 meet the requirements with minimum resources: 1) cameras are fixed, and the domain of the observing environment will not change; hence the system 100 can use temporal knowledge adaptation and use a lighter model at inference time; 2) as cameras will be installed on traffic or street lights pole (15 feet, with 15-degree angle), the relative speed is significantly slower compared to other applications such as autonomous vehicles hence a high frame-rate detection is not needed. Moreover, target objects take a small portion of the whole frame. Hence, the system 100 can focus on location with a chance of an object's existence.

The system 100 focuses on reducing the model computation complexity by reducing the model input size. Mainly, DNNs are applied to all pixels in visual feature extraction as there is a data dependency between pixels. Here, the system 100 uses a light neural network to decompose images into sub-regions and then applies a deep neural network to regions of interest (Rol). The light neural network is considered as a pre-processing step and can be implemented in various fashions.

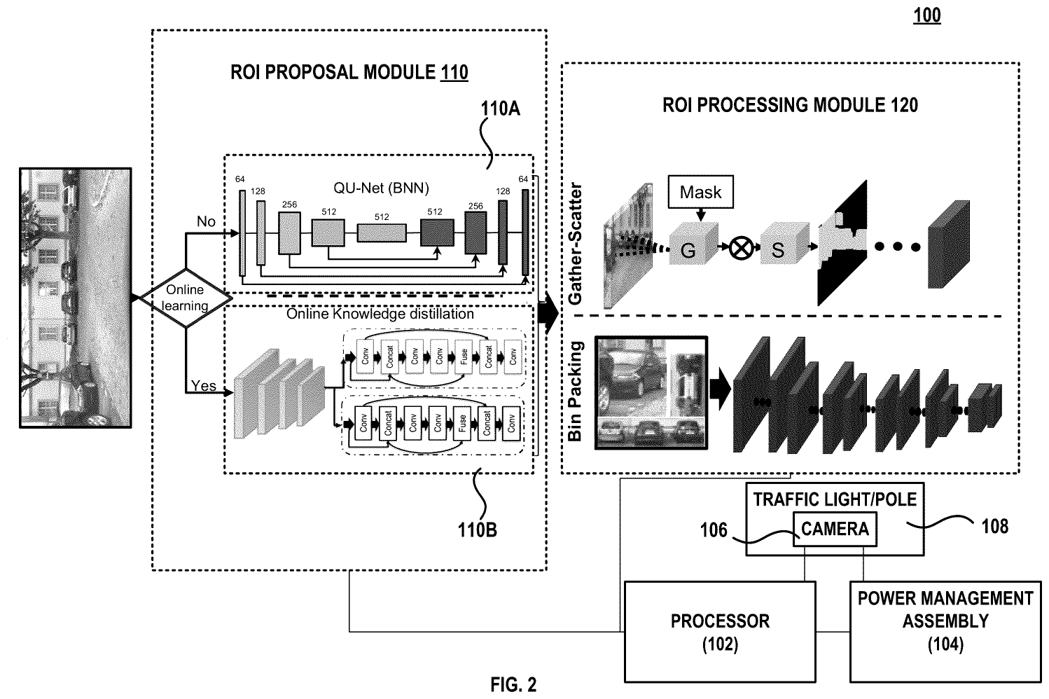

An overall view of the system 100 is shown in FIG. 2. The system 100 generally includes at least one processor 102 in communication with a power management assembly 104 (e.g., a battery and one or more solar panels) and a camera 106 that captures input frames including images associated with vehicular traffic for object detection by the processor 102 as described herein. In some examples, one or more of the processor 102, power management assembly 104, and/or camera 106 can be implemented along a traffic light/pole 108 as indicated for vision-based intersection management. As further shown, the system 100 includes an ROI proposal module 110 that proposes one or more Rols within the input image that have a high probability of object existence, followed by an ROI processing module 120 that processes the Rols in a neural network. The ROI proposal module 110 can be formulated in a couple of ways, namely using a BNN-based Rol proposal model 110A (also referred to herein as QU-Net) and/or a light model 1108 that performs knowledge distillation. The ROI processing module 120 can also be implemented in more than one way and can incorporate a bin-packing algorithm or a gather-scatter method.

In one aspect, the system 100 implements a binary Rol proposal model 110A, QU-Net (FIG. 2), that efficiently predicts regions with a high probability of object existence. QU-Net is a binary neural network (BNN) which generates a binary segmentation mask. The regions proposed by this module can have a single object or multiple objects (if objects partially occlude each other). As QU-Net uses a BNN backbone, its computation and memory cost is meager and can be applied to high-resolution images. Furthermore, the method implemented by the system 100 is general, unlike Skipnet or Dynamic convolution, which is only applicable to residual convolutional neural networks (CNNs).

Second, this concept can be extended to methods based on online (or temporal) knowledge distillation. As mentioned, in these models, the light model 110B adapts to the environment using a deep model output on keyframes. An eminent issue is the keyframe selection and processing using an expensive model. Even with scene changes only happening in parts of the input frame, models at the earlier stages of the pipeline have to process the keyframe entirely. Following this observation, a straight-forward idea is to only process the Rols and reuse previously extracted features for the rest to improve recognition execution performance at inference time.

The system 100 adopts the light model 1108B as an Rol proposal model (by reducing the network's confidence). The system 100 also uses an event-based mechanism to improve Rol identification. After decomposing the input frame to separate Rols, the system 100 applies the deep model to those regions at the ROI processing module 120. Such a system design can reduce the computation by skipping processing a substantial portion of the input frame that are not challenging or have an object.

The present disclosure provides two methods that can be implemented by the system 100 to process the Rols in a neural network at the ROI processing module 120. A first method is a gather-scatter approach. This method is more efficient than other sparse matrix operations because it gathers the elements into a single dense matrix before applying the convolution operation. However, this method requires the implementation of custom layers for each neural network. A second method is Bin-packing, which allows the system 100 to process the Rols by extracting each rectangular region of interest from the image and packing them into a batch of frames. This method is highly flexible and can be applied to any pre-implemented neural network with no layer-wise dependency, at the cost of adding extraneous areas.

To validate the effectiveness of the system 100, extensive empirical studies are presented herein that were performed on the COCO, Cityscapes, WiseNet and UA-DETRAC datasets. The present disclosure provides a comparison of performance of the system 100 with Dynamic Convolutions as well as other state-of-the-art methods with a set of evaluation metrics, including recognition accuracy, processing time, and energy consumption. The system 100 showed a computation reduction of 25% and 57% on COCO and Cityscapes datasets, respectively, with a marginal average accuracy loss of 4% and 1.5%. Moreover, the system 100 reduces the computation by 20% and 40% compared to the dynamic convolutions approach in object detection and segmentation tasks while improving the mAP by 3% and 20%. The system 100 reduced the computational cost by 89% and 80% on UA-Detrac and Wisenet with a marginal decrease in accuracy, 3%. The main contributions of this work are:

A novel mechanism to decompose the incoming frames into small independent sub-regions. This mechanism reduces computation time and energy consumption.

A binary segmentation model (QU-Net) which can efficiently propose region of Interests (Rols).

Extending the system 100 to a verity of DNNs such as transformers and online knowledge distilation.

A full-stack developed system on-device with extensive experimentation. FIG. 1 shows an initial prototype for vIM using the system 100.

### 2. Related Work

### 2.1 Object Recognition

CNN-based object detection methods can be categorized into two groups: two-stage and single-shot detectors. In two-stage techniques such as GP-FRCNN and FG-BRNet, a region proposal network (RPN) localizes regions with a likelihood of object presence, followed by a classification stage. Attempts are made to improve this category of detectors' performance by adaptively adjusting the input image resolution, processing challenging regions with a separate CNN model or using a selective mechanism to reduce the number of proposed regions by the RPN. In single-shot approaches such as YOLO, and SpotNet, the inference is performed in a single pass by combining region proposal and classification stages. The system 100 adopts single-shot detectors in experiments considering their higher efficiency. Note, the system 100 can be applied over two-stage approaches as well such as Faster RCNN.

Image Segmentation, or the task of locating the objects and boundaries in images, is another application for CNN-based methods. Models have been proposed which reduce the memory consumption and computation. But research has shown that the performance of SegNet deteriorates when there are multiple objects in the scene. Further, DeepLab and PSPNet are improved segmentation models, but these come at the cost of higher computation cost as well. U-Net is a CNN that was developed for image segmentation in the biomedical field. U-Net includes an encoder that extracts the salient features from the image and a decoder that enables the reconstruction of the binary mask that gives locations of the objects of interest. Binary segmentation (single class segmentation) has been explored in the past for medical images. The system 100 extends the U-Net model (quantized and binarized) to fit different use cases for the task of binary segmentation.

### 2.2 Dynamic Neural Networks

Dynamic neural networks are networks that can adapt their structures or parameters to varied inputs, allowing them to achieve superiority in terms of computational efficiency and accuracy. Recently, these networks formed a key part of several literature studies. Sample-wise dynamic networks take into consideration that different inputs may have different computational demands. Skipnet, and SACT exploit this assumption and dynamically adjust the layers based on the complexity of the image. Temporal-wise dynamic networks rely on the fact that specific frames may contain redundant information. This information can allow the networks to execute the critical frames selectively. These methods rely on the assumption that certain input frames can be effortless to process while spatial-wise dynamic convolutions rely on region-wise complexity, which is more suited towards real-time scenarios since every image can contain challenging regions.

Spatial-wise dynamic convolutions exploit the fact that the different regions in an image con-tribute unequally to feature extraction and focus the execution on the regions with a probability of containing an object of interest. Background subtraction estimates the difference between successive frames to estimate the moving objects has been widely used in the realm of identifying the regions of interest for spatial processing by dynamic neural networks. However, these methods work on certain fixed assumptions and lack the flexibility to handle natural movements in the environment as well as the movement of the camera. Pixel-level dynamic networks are a type of spatial-wise method that performs adaptive computation at the pixel level. Dynamic Convolutions is one such approach that uses a mask to execute specific regions with crucial information for feature extraction. Dynamic Convolutions rely on residual blocks, and after each block, create an attention mask and only process selected regions. Therefore, a smaller spatial area for processing help in reducing the overall computational cost of the network. One method implemented by the system 100 has the same functionality; however, the system 100 does not rely on features extracted from residual blocks, making it more general. Moreover, the system 100 can reduce the initial layer computation as the Rols are extracted using the pre-processing mechanism of the system 100.

### 2.3 Quantized Neural Networks

In CNNs, the main contributors to the complexity of a model are the convolutional operations because of the significant overhead of the repeated multiplication functions. Many methods have been proposed to reduce this overhead. Reducing the bit-width of the activations and weights has been one of them that helps in reducing the complexity of the respective layers. Binarized Neural Networks and XNOR Net took it further by proposing methods to binarize the weights and activations of the entire network. However, an entire binarized neural network is not feasible because of the accuracy loss. A layer-wise priority for binarization is used to alleviate the problem. As the binarization of deep layers leads to a lower accuracy drop, they use a bottom to top approach.

To counter the issue of the accuracy loss during binarization, flexible models which sup-ported the use of different bit widths were developed. DoReFa-Net introduced a method to train models using low bit-width weights and activations as well as efficiently implement them on different hardware devices such as FPGA, CPU, etc. Furthermore, DoReFa-Net provided an efficient method to quantize the different layers. But all these models proposed had been tested on image classification and object detection and still cannot be applied on real application due to high accuracy degradation. By considering this fact, the system 100 adapts BNNs as a pre-processing mechanism to improve the CNNs performance. The binary segmentation model of the system 100 can recognize the interest areas for various objects and reduce the computation of DNN by reducing the processing regions.

### 2.4 Online Knowledge Distillation

Online Knowledge distillation is an approach to transferring information from one model (teacher) to another (student) at inference time. This approach trains an efficient model to mimic the output of an expensive teacher as a form of model compression. Early explorations of knowledge distillation focused on using the teacher's rich output to train the student over the entire original data distribution. New studies adopt it in online learning and show benefits. One such example adopts online knowledge distillation to improve inference time for image segmentation. A light model is used for inference, and at fixed intervals, it extracts features from the selected frames (keyframes) with an expensive model to train the light one. Instead of using fixed intervals, one study proposes an adaptive mechanism to select keyframes. A recent study shows that processing the keyframe on embedded devices will hurt the inference time and energy consumption. The system 100 can be extended to online knowledge distillation without relying on keyframe processing. Instead, the system 100 applies the expensive CNN model on Rols, not the whole frame. The Rols are detected based on light model output with low confidence. Moreover, a loss function is designed to use partial information extracted from Rols combined with information extracted in early detection to train the light model.

### 2.5 Video Object Detection

Temporal cues have been used in video processing to reduce computational costs. Researchers adopt optical flow or recurrent network architectures to modify the previous frame's extracted features and reuse the features for current frame detection. These approaches heavily rely on the keyframe mechanism, which is computationally expensive. Moreover, it can increase the response time when we have a new object in the scene. One study suggests the usage of external sensor data (LiDAR) to select regions for further processing; however, this information is not available in all applications. The system 100 has an agile detector (pure vision-based) that detects Rols and applies an expensive CNN model on them. Furthermore, the system 100 can retrain itself (based on implementation) to avoid future repetitive requests.

### 3. System

The core of the system 100 is the Rol proposal module 110 (e.g., a decomposing image module), which locates Rols in input frames and creates independent sub-regions for deep feature extraction. The system 100 can be implemented in active or passive mode. In passive mode, the system 100 detects Rols as a pre-processing stage and reduces the DNN module's input size (and computation). The system 100 implements this configuration using a binary region proposal, namely the BNN-based Rol proposal model 110A (also referred to herein as QU-Net). In active mode, outputs from these regions can be aggregated with early detection to train the light model 1108 (which also functions as the Rol detector) and reduce the number of future operations in the online knowledge distillation methods. In the following, the present disclosure describes these two main approaches to implement the system 100; 1) using a binary neural network for the BNN-based Rol proposal model 110A (Passive), 2) using the light model 1108 in online knowledge distillation methods (Active).

### 3.1 Binary Region Proposal

Due to the memory and computation efficiency, Binary neural networks (BNNs) have received significant attention in recent years. However, these models cannot achieve high accuracy on complex problems such as object recognition. Therefore, the system 100 adapts the BNN-based Rol proposal model 110A as a pre-processing step for proposing Rols, which is a binary segmentation. Here, it is necessary to find regions with a high probability of object existence. This task is much easier compared to semantic segmentation or object detection. Different methods were tested to reduce the computation of this model (the so-called “OU-Net”).

Architecture: One implementation of the system 100 adapts the U-net architecture as the baseline. Leveraging aspects of the U-net architecture, the is divided into three parts with different quantization structures to develop a light version of U-Net. The backbone of the network used binary modules with the final layers using binary weights and 4-bit activations. Moreover, instead of using full precision on early layers, the layers are quantized to improve inference time without affecting accuracy.

For a convolutional neural network, the first layers are critical as any information that is lost during the first layers cannot be reclaimed at later stages. Thus, it is essential to ensure that the relevant information is passed down with minimal disruption. The system 100 achieves this by using 1-bit weights and 8-bit activations in the convolution layers at the initial stage and the following two downsampling stages (the yellow regions in FIG. 2).

Once the initial layers extract the relevant features, the information capacity can be reduced with minimal loss of information. Therefore, the last two downsampling layers were replaced with 1-bit weights and 1-bit activations in QU-Net model (the gray regions in FIG. 2). One initial approach was to use Melius Blocks which include a DenseBlock and Improvement Block that helps maintain the feature quality, especially with the increase of channels in the last few downsampling layers. However, it was not found to contribute significantly to the accuracy based on experimentation results. Thus, in one embodiment of the system 100, the convolution layers were replaced with the DoReFa-Net based binarized modules.

It is important for the relevant information to flow up to the final layer to reconstruct the binary mask from the extracted features. Experiments showed that reducing the activation layer bandwidth to less than 4-bits led to severe accuracy degradation. Therefore, the system 100 uses a 1-bit weight and a 4-bit activation to ensure that the information captured in the downsampling layers is fed through the upsampling layers (represented by dark green regions in FIG. 2) to the final feature map. The last layer is full-precision to provide a dynamic range of values that are obtained in the one-hot output tensor.

Each convolution layer with quantized weights and activations also has a squeeze and excitation block. This approach can help in modeling channel-wise attention and increasing the information capacity of the model with a negligible increase in computation cost.

Forward and Backward Propagation: In QU-Net, the entire model is composed of 1-bit weights except for the last layer. The weights are binarized using the sign function that rounds each value to the closest integer in the set {−1,1}as defined in Eq. 1. To solve the issue of the non-differentiability of the sign function, the Straight-Through Estimator (STE) was used which passes the output of the gradient as it is.

$${D}_{t} ( x , y ) = \{ \begin{matrix}+ 1 if x \geq 0 \\ - 1 otherwise\end{matrix} \qquad ( 1 )$$

Each weight parameter also has a multiplicative scalar constant associated with it that allows the increase in the range of weights while still utilizing bit convolution kernels. This technique led to the use of a scalar constant for each weight which is equal to the mean of all the absolute values in the specific parameter as defined in Eq. 2. This method allows the network the flexibility to use bit-convolutional kernels both in forward-propagation as well as back-propagation.

The activation quantization methodology followed three different representations depending on the depth of the layer. The system 100 adopts quantization functions as defined in Eqs. 2 and 3. Here, rᵢ represents the number in the real format while rₒ is the quantized version of the number with k representing the number of bit representation.

Forward pass:

$${r}_{o} = \{ \begin{matrix}sign ( {r}_{i} ) \cdot mean ( abs ( {r}_{i} ) ) if weight \\ \frac{1}{{2}^{k} - 1} round ( ( {2}^{k} - 1 ) {r}_{i} ) if activation\end{matrix} \qquad ( 2 )$$

Backward pass:

$$\frac{d l}{d {r}_{i}} = \frac{d l}{d {r}_{o}} \qquad ( 3 )$$

Training: Training of the system 100 is performed for a standard 50 epochs. In one embodiment, the system 100 is trained using an RMSProp optimizer with a learning rate of “1e-5”, weight decay of “1e-8”, and momentum of “0.9”. A lower learning rate than usual is used to account for the small range of the weight values. The weights are binarized at forwarding pass, but each back-propagation step involves calculating the gradients on the real-valued weight tensors. In one embodiment, all of the training steps are performed on images of resolution 320×320. Although the initial training is performed on 640×640 images, it was found that the reduction in accuracy was negligible, allowing the system 100 to use a lighter model. Using a lower resolution of 640×640 increased the selected area drastically, making it unfeasible for use as a region proposal network. For deeper networks, images of 640×640 resolution are used.

A primary focus in building the region proposal aspect of the system 100 was to ensure that all the objects were detected with very few missed objects. Therefore, the loss function was modified to provide more weights to the foreground class with a lesser focus on the background class. In one embodiment of the system 100, the loss function is a combination of weighted CrossEntropy+scaled Dice loss. This is at the expense of a larger number of false positives but allows the capture of most of the regions, which are essential to a region proposal network such as the system 100.

$${L}_{r o i} = - {weight}_{c e} [ 0 ] * log ( exp ( x [ 0 ] ) / ( {\sum }_{j} exp ( x [ j ] ) ) ) - {weight}_{c e} [ 1 ] * log ( exp ( x [ 1 ] ) / ( {\sum }_{j} exp ( x [ j ] ) ) ) {sf}_{d c} [ 0 ] * \frac{\sum {p}_{0} {g}_{0}}{\sum {p}_{0} + \sum {g}_{0}} + s {f}_{d c} [ 1 ] * \frac{\sum {p}_{1} {g}_{1}}{\sum {p}_{1} + \sum {g}_{1}} \qquad ( 4 )$$

Here, the cross-entropy losses are defined by the initial two parts of Eq. 4 where x represents the class probability. Each class (0,1) also has a corresponding weight weight_{ce} associated with it, equal to the inverse number of samples in the class. The following two parts of the equation represent the dice coefficients for each class with a scale factor (sf_{dc}) associated with each class. The scale factor is the inverse ratio of samples summing to 1. Here p represents the predicted labels, and g represents the actual labels. It helps measure the overlap between the two sets and improves accuracy when combined with the cross-entropy loss.

Validation: The predicted mask includes a 2-dimensional vector containing the values for each class (binary). This is reduced to a one-dimensional vector where elements indicate the argument for the maximum score, with 0 being the background and 1 being the foreground. The final output is dilated to ensure the surrounding regions around the objects are covered, which is essential in visual recognition tasks such as segmentation where the surrounding context can help improve the accuracy. The validation study is focused on testing the validity of the algorithm on the two main metrics:

The number of regions detected with an IOU threshold of 50%, 75%, and 95%; and The amount of area covered by the true positives compared to the actual area of labels.

3.2 Online Knowledge Distillation

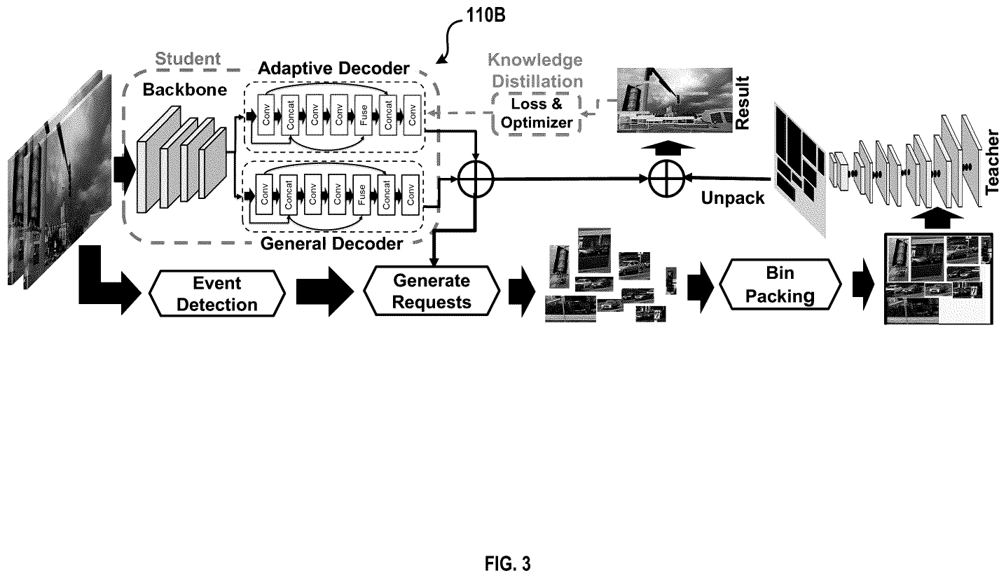

To show the generality of the system 100, the system 100 is extended to online knowledge distillation models, shown in FIG. 3. In these models, there is a light (or shallow) model which adapts to the observed environment. The QU-Net is swapped with the light model 110B in these types of feature extractors. Next, the low confidence output of the light model is taken with an event detection mechanism to propose Rols that need deep processing. The use of multiple feature extractors can improve the response time of the system 100 while maintaining accuracy. This method has benefits specifically when implemented using fixed cameras (similar to vIM), as the distribution of objects does not change significantly. The system 100 was implemented within this overall methodology using the following steps. First, the light detector (student) plays the role of the initial object detector and region proposal (Rols). Student output includes two types of detections: 1) Objects with low confidence; 2) Objects with high confidence—objects with high confidence considered as accurate detections. Regions with low confidence detected objects are selected as Rols. This methodology is combined with a background-foreground subtraction (camera is fixed) to select Rols in which an event was observed to improve the performance. Next, deep feature extraction is applied to the Rols using the deeper model (teacher). Using the extracted feature by the teacher, the student is updated to avoid future requests.
3.2.1 Event Detection

To identify the challenging regions (Rols), the system 100 adopts a decision mechanism with motion detection; specifically, a Forgetting Morphological Temporal Gradient (FMTG). FMTG implements a nonlinear ΣΔfilter, which is known for an efficient analog to digital conversion. Formally, the system 100 computes a current background image Mₜ and a time-variance image Vₜ iteratively:
Compute mean over incoming frames, I₀, . . . , Iₜ₋₁, Iₜ:

M₀(x,y)=I₀(x,y),

Mₜ(x,y)=Mₜ₋₁(x,y)+sgn[Iₜ(x,y)−ₜ₋₁(x,y)],

Δₜ(x,y)=Mₜ(x,y). (5)
Compute the variance:

V₀(x,y)=Δₜ(x,y),

if Δ≠0,Vₜ(x,y)=Vₜ₋₁(x,y)+sgn[N×Δₜ(x,y)−V₍ₜ₋₁₎(x,y)]. (6)
Motion label:

$${D}_{t} ( x , y ) = \{ \begin{matrix}0 if {Δ}_{t} ( x , y ) < {V}_{t} ( x , y ) \\ 1 otherwise\end{matrix} \qquad ( 7 )$$

Here, N denotes an amplification factor for new incoming frames. This procedure can produce small noisy regions inside selected regions (false negatives) and also not selected regions (false positives), which are called “bubbles”. Therefore, the system 100 applies a dilation filter on the output, followed by an erosion filter.
3.2.2 Further Processing Requests Generation

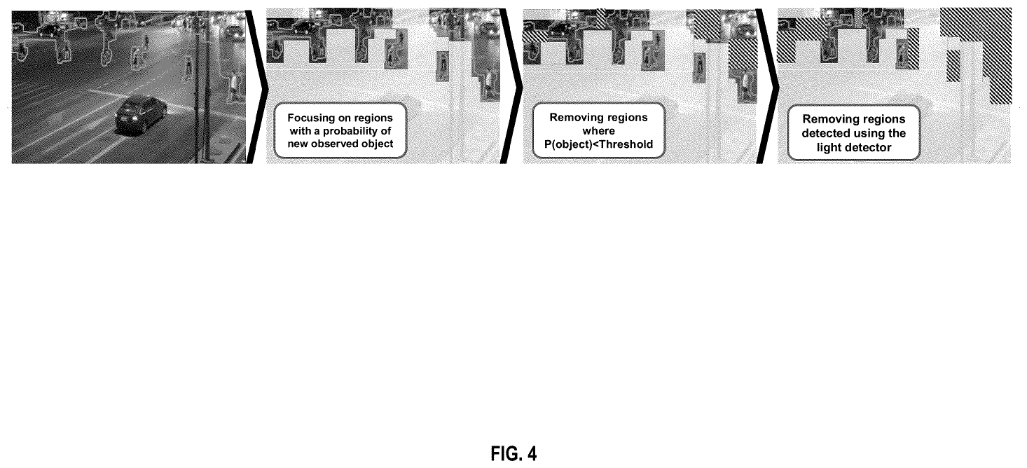

After the initial detection and Rols, we locate areas that need further processing. As shown in FIG. 4, the system 100 segments the image into sub-regions and focuses on those regions which have activity based on event detection. Next, the system 100 removes regions with a low chance of object existence based on the general decoder's output, P_{R} (object)<┌, where the ┌ could be tuned based on the desired recall on the validation set during training time. Experiments showed that the adaptive decoder loses its generality at inference time; hence the system 100 implements a general decoder for region selection. Finally, the system 100 checks the “intersection over union” (IOU) of these regions with objects the adaptive decoder has detected earlier. If the adaptive decoder already detected objects, the system 100 removes them from future processing.
3.2.3 Knowledge Distillation Stage

In this stage, the system 100 uses the consolidated results from the previous module to improve the light detector or student. This action will reduce future requests (in-depth processing) and improve the response time by detecting most of the objects using the student model. Back-propagation based training relies on a loss function comparing the student and teacher output. As the consolidated results have been produced by combining the student and the teacher, teacher output is inaccessible over the whole frame; consequently, a new loss function is needed to train the student using partial knowledge.

Previous efforts adopt a combination of student's and teacher's outputs as the ground truth for supervised student retraining, to avoid a sharp shift of the student model towards teacher's output and thus preserve student's knowledge by the following loss function:

L_{final}=Σ∥Tₛ^{H}−Tₜ^{H}∥₂²+Σ∥T_{S}^{L}−((λ*Tₛ^{L})+((1−λ)*Tₜ^{E}))∥₂², (8)

where λ denotes the modulation factor in their weighted loss function. T_{S}^{H} and Tₜ^{H} are the students and teacher output tensors with high confidence in object existence and Tₛ^{L} and Tₜ^{L} tensors with low confidence. This loss function needs the teacher and student to have a similar structure (single-shot).

To have a detection-model-agnostic system, the loss function of the system 100 should be general enough to work with any object detection model as a teacher (single-shot or two-stage detector). Second, the loss function of the system 100 should maintain the current knowledge of students while distilling new information. To this end, the system 100 implements a loss function that fulfills the design requirements. First, the following losses are calculated:
Localization loss:

$${L}_{loc} = \frac{1}{D} {\sum }_{𝔻} ( 1 - GIOU ( {B}_{i , j}^{S} , {B}_{i , j}^{T} ) ) + \frac{1}{N} {\sum }_{ℕ} {‖ {B}_{i , j}^{S} - {B}_{i , j}^{T} ‖}_{2}^{2} , \qquad ( 9 )$$

$$where , {B}_{i , j} = ( x , y , w , h ) , {C}_{i , j} = ( {c}_{1} , … , {c}_{n} ) , 0 \leq {O}_{i , j} \leq 1 ,$$

$$𝔻 = \{ αα is a region processed by teacher . \} , - N \text{"=\{αα∉𝔻\}}$$

Classification Loss (with Binary Cross-Entropy (BCE)

$${L}_{cls} = \frac{1}{D} {\sum }_{𝔻} B C E ( {C}_{i , j}^{S} , {C}_{i , j}^{T} ) + \frac{1}{N} {\sum }_{ℕ} {‖ {C}_{i , j}^{S} - {C}_{i , j}^{SI} ‖}_{2}^{2 ,} , \qquad ( 10 )$$

$$where ,$$

$$σ ( x ) = {e}^{x} / ( {e}^{x} + 1 ) , B C E ( ( {x}_{1} , … , {x}_{n} ) , ( {y}_{1} , … , {y}_{n} ) ) = {\sum }_{n} - {w}_{i} [ {y}_{i} . log ( σ ( {x}_{i} ) ) + ( 1 - {y}_{i} ) . log ( 1 - σ ( {x}_{i} ) ) ]$$

Here, w is for weighting classes in an unbalanced dataset.
Objectness Loss with generalized intersection over union loss (GIOU)

$${L}_{o b j} = \frac{1}{D} {\sum }_{𝔻} BCE ( {O}_{i , j}^{S} , {O}_{i , j}^{T} ) + \frac{1}{N} {\sum }_{ℕ} {‖ {O}_{i , j}^{S} - {O}_{i , j}^{SI} ‖}_{2}^{2} . \qquad ( 11 )$$

B, C, and O are the box coordinates, class label, and object existence probability for each cell in the student's output tensor. Student output before training is denoted as B^{SI}, C^{SI}, and O^{SI}. The student's output after each iteration is denoted as B^{S}, C^{S}, O^{S}and the teacher's output is denoted as B^{T}, C^{T}, O^{T}.

The system 100 calculates the overall loss by summing the localization, objectness, and classification loss in each training iteration: Loss=λ_{loc} L_{loc}+λ_{obj}Lₒᵥⱼ+λ_{cls}L_{cls} where λ_{loc}, λ_{Obj}, and λ_{cls} are modulation factors. This overall loss function can take the ground truth from any object detector as a teacher as it takes detection coordinates and class for training.

### 3.3 Masking

Rols can be processed separately or batched. The system 100 aims to process these requests using a GPU accelerator as they are efficient in performing batch processing. The proposed regions (the output mask of Rol detector) could be processed by the ROI processing module 120 in two fashions: 1) bin-packing; 2) Gather and scatter.

In one aspect, the system 100 adopts a bin-packing algorithm to put the regions (Rols) next to each other, which is different from a conventional batching method due to the various sizes of the “proposed regions”. The bin packing problem for two-dimensional objects is NP-hard. Therefore, the system 100 adopts the “Maximal rectangles best short side fit”, a heuristic algorithm. Using this heuristic approach reduces the execution time for packing, which is negligible compared to the input frame's processing time through the teacher model. Furthermore, during experimentation, it was found that the system 100 can accommodate dynamic bin sizes. Therefore, if the teacher model could also accept dynamic input sizes, it could significantly reduce the computation.

The system 100 could also use the gather-scatter method to perform efficient tensor computation. The gather step takes each active position in the tensor and consolidates it to a smaller tensor, after which the normal convolution is applied. This is mapped back to the original tensor using the scatter method. Thus, it is effectively equal to performing operations on a smaller image based on the number of active positions with adding less overhead to the overall operation. Although this method focuses on the active regions with no outside areas processed, additional effort is required to implement a custom layer.

### 4. Experiments

To validate the system 100, different experiments are presented herein to compare the system 100 with state-of-the-art methods. In the following, the present disclosure provides experimentation results in two separate configurations; 1) Based on the Binary neural networks, 2) Based on online knowledge distillation.

### 4.1 Experiment Setup

Hardware: The embedded device is the NVIDIA Jetson Nano developer kit, a quad-core ARM A57 CPU (operating at 1.43 GHz), 4 GB 64-bit LPDDR4 RAM, and 128-core Maxwell GPU. A 2 GB swap memory is also assigned to accommodate the memory overflow that can occur while testing heavy DNNs such as SpotNet as the memory is shared between CPU and GPU. The power consumption is measured using the tegrastats utility. The training and other experiments were conducted on a Dell workstation with an Intel Xeon W-2125 CPU and an NVIDIA Titan Xp.

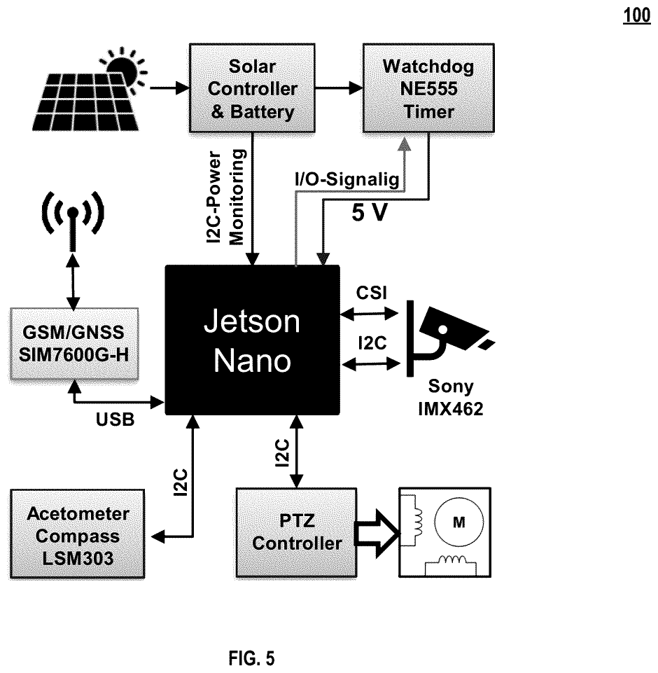

The prototype version of the system 100 for vIM tests is implemented at a busy intersection as shown in FIG. 1. FIG. 5 shows a block diagram of the system 100 for the vIM implementation. A solar panel powers the visual system. The IMX462 camera observes the scene, and detected objects are sent to the server using NB-IoT network. In addition, a watchdog is also included for checking system low-level functionality, an accelerometer/compass, and a GNSS sensor used for localizing the field of view.

Dataset: The Binary proposal model or QU-Net are evaluated on the Cityscapes dataset which focuses on vehicle object detection and semantic understanding of urban street scenes. The Cityscapes dataset includes 3475 fine annotated images for train and validation sets. The Cityscape dataset was split into 2975 training images and 500 validation images. Apart from that, the model of the system 100 was also trained on the COCO dataset to test the performance on a large number of classes. The 2017 part of the COCO dataset was used, which includes 118k training and 5k validation images.

The online knowledge distillation (implemented using the system 100) was also evaluated on UA-DETRAC and WiseNet datasets. These datasets were selected for this purpose as the camera is stationary, and the event-based mechanism can be used. UA-DETRAC has 140,000 frames of real-world traffic scenes. In this dataset, 1.2 million vehicles are labeled with bounding boxes. The videos were recorded at 25 frames per second (fps) in the JPEG format, and the resolution of images is 960×540 pixels. Experiments were also conducted on the WiseNet dataset to study the performance of our proposed design for indoor scenarios. The WiseNet dataset includes 62 videos recorded using six cameras for people detection and tracking.

Deep Learning platform: All experiments were performed using PyTorch library, which is also used for evaluating the performance of other methods.

### 4.2 Binary Region Proposal

The BNN model (QU-Net) of the system 100 was tested for Rols proposal on different configurations to evaluate the effect of other compressing mechanisms on the model of the system 100. The gather-scatter approach was used to apply the mask during experimentation on QU-Net. Although the binary region proposal model can result in increased computational complexity, experiments showed that it is very minimal compared to the actual complexity of the deeper models. Thus, applying it to the image can reduce the overall computation significantly.
4.2.1 Quantization and DCT-based approach

Initial experiments were performed to analyze two different methods to reduce the computation of a network.
The effect of quantization on the U-Net network;
The effect of using a 2D type II discrete cosine transform on the image to obtain a downsampled version that can be used as input to the network.

Quantization based approach: In CNNs, the main contributor to the complexity is the convolution operations. These operations have a significant overhead due to the repeated multiplication functions and heavy memory communications. Binarization can alleviate this overhead at the expense of accuracy drop. To understand how the binarization of each module affects accuracy, various experiments were performed as shown in Table 1. The quantized model reduced computation by a factor of 10 when compared to the full precision model. Moreover, the model occupied a space of 2MB, which allows us to fit the model on various low-memory devices. It can also be seen that the quantized model detects a close percentage of Rols as the full-precision model, with a minor increase in the total area of the image captured.

| | Initial | Middle | Upsampling | | | |
|---|---|---|---|---|---|---|
| | Layers | Layers | Layers | Rols | | |
| | Quantized | Quantized | Quantized | De- | Area | |
| DCT | (8 bit/ | (1 bit/ | (4 bit/ | tected | Pro- | FLOPs |
| Input | 1 bit) | 1 bit) | 1 bit) | (%) | cessed | (G) |
| No | No | No | No | 98.36 | 0.3658 | 62.68 |
| No | No | Yes | No | 98.23 | 0.3689 | 55.27 |
| No | No | Yes | Yes | 98.23 | 0.3870 | 18.36 |
| No | Yes | Yes | Yes | 97.97 | 0.3815 | 5.30 |
| Yes | Yes | Yes | Yes | 99.66 | 0.9820 | 0.112 |

DCT based approach: Along with quantization, to further reduce the computation cost, a DCT based method is included to reduce the computations of the overall network further. One study reported that applying DCT can reduce the computation cost of CNN models. However, as reported in table 1, experiments showed that a DCT-based approach for QU-Net did not bring any benefits in reducing the computation of deeper models. The output of the DCT based region proposal model did not conform to the actual object presence locations, which resulted in a large area being captured on dilating the outputs. The DCT model proposes 99% of the images as the regions of object presence (Rols), equivalent to sending the entire image through the deeper network. Comparatively, the non-DCT approach selected only 38% of the images.

The system 100 was tested on two main applications of computer vision—object detection and segmentation to observe its effect on the accuracy and computation of proposed methods in these domains. The system 100 was also compared with dynamic convolution. Dynamic convolution tries to reduce the processing regions on residual neural networks such as ResNet. This type of convolution neural network has a computational budget parameter that can be set which determines the relative amount of FLOPs that should be executed. For example, a value of 0.25 indicates 25% of the FLOPs should be executed. To have a fair comparison, a value of 0.25 was used as the budget in all experiments. The system 100 is shown to outperform the dynamic convolution in both cases.

Object Detection: As mentioned, the dynamic convolution requires a model implemented using a residual backbone. Hence, used a YOLO model with a ResNet-101 backbone was implemented as the baseline model (the model of the system 100 can be plugged into any prebuilt framework). QU-Net of the system 100 was trained on the Cityscapes dataset separately for 50 epochs. Both the baseline and the dynamic convolutions (with a 0.25 budget) were trained for 200 epochs. Models were evaluated on the person detection annotations (CityPersons) as provided on the official website. Table 2 shows the outperformance of ARGOS compares to the dynamic convolution approach. A combination of our model with the baseline model enabled a reduction of FLOPs by 50%. It was 6 GFLOPs lower than the dynamic convolutions along with an mAP gain of close to 3%. Moreover, the reported FLOPs are the computation cost of both the deeper model and QU-Net.

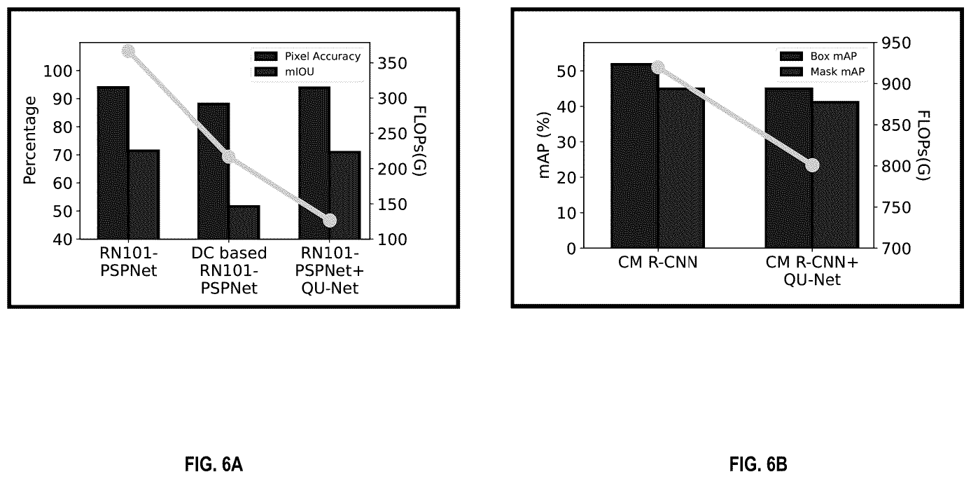

Segmentation: The PSPNet model with the ResNet-101 backbone was used as the baseline model. The model of the system 100 was trained on the Cityscapes dataset separately for 50 epochs. The baseline model and the dynamic convolution were trained for 120 epochs each with a 0.25 budget. This was evaluated on the instance segmentation classes in the Cityscapes dataset. FIG. 6A shows the system 100 outperforming the dynamic convolution with an mAP gain of close to 20%. The system 100 has a computational reduction of 62%, whereas the dynamic convolution achieved a reduction of 41%.
4.2.2 COCO Dataset

To further understand the scalability of the system 100, experiments were performed on the COCO dataset using the YoloV5 (CNN) model and the Swin (Transformer) model. These experiments show how the system 100 performs when there are more classes than present in the Cityscape dataset tests.

The original models were used as the baseline and evaluated the performance with the QU-Net model of the system 100, and without it.

The comparison between the Yolov5 and QU-Net (of the system 100)+Yolov5 model is shown in Table 2. There was a significant reduction for the Cityscapes dataset (57%) with a slight reduction in model accuracy. For the COCO dataset, the decrease was less pronounced (25%). For the Swin transformer (FIG. 6B), the system 100 reduced the number of FLOPs by 114 GFLOPs with a 4.8% reduction in object detection accuracy and 3.8% in instance segmentation accuracy.

The COCO dataset includes images where most of the objects were captured at a close range. This increases the total area occupied by the objects when compared to other real-world datasets such as Cityscapes. The system 100 exploits the real-world assumption of objects occupying a smaller area compared to the background. Thus, the reduction in computational cost is larger when the system 100 is tested on the Cityscapes dataset compared to the COCO dataset.

### 4.3 Online Knowledge Distillation

One study showed that online knowledge distillation could reduce the computation of convolutional neural networks using temporal adaptation to the observing environment. However, their experiments showed that the keyframe selection and processing are expensive for embedded devices and need to be processed on the cloud. Therefore, the system 100 was tested for this type of CNNs to validate its effectiveness. In addition, the experiments were conducted on Jetson Nano to study the performance of the system 100 in a constrained environment.
4.3.1 UA-DETRAC Dataset

Training: The student model and the teacher model were pretrained on COCO dataset. Then, the pre-trained models were fine-tuned on the UA-DETRAC dataset (offline training). The “bag of freebies” was used to improve the accuracy during the offline training stage. In Knowledge distillation and training, the ADAM optimization was applied for end-to-end training. The optimization was performed in the 16-bit numerical format at the inference time. To improve the performance in 16-bit precision, 1e-4 was added to the denominator (backpropagation stage) to improve numerical stability during online knowledge distillation.

Evaluation Metrics: The evaluation metric for accuracy in the UA-DETRAC detection benchmark is stringent: the Mean Average Precision (mAP) with a high Intersection over Union (IOU) threshold set to “0.7”. As the target is embedded devices, both the inference time and energy need to be considered in evaluations. The inference time (FPS) and its effect on real-scenarios accuracy was studied. The ratio of mAP to energy consumption is used to evaluate the overall efficiency in terms of accuracy and energy consumption. The proposed methods are ranked using this metric in Table 3 (note: “ARGOS” in Table 3 is the system 100).

| | Overall | Easy | Medium | Hard | Cloudy | Night | Rainy | Sunny | FPS ↑ | FPS ↑ | Energy | Score |
|---|---|---|---|---|---|---|---|---|---|---|---|---|
| Model | % ↑ | % ↑ | % ↑ | % ↑ | % ↑ | % ↑ | % ↑ | % ↑ | WS | Embedd | (J) ↓ | ↑ |
| FG-BR Net | 79.96 | 93.49 | 83.60 | 70.78 | 87.36 | 78.42 | 70.50 | 89.8 | 10 | — | — | — |
| HAT | 78.64 | 93.44 | 83.09 | 68.04 | 86.27 | 78.00 | 67.97 | 88.78 | 3.6 | — | — | — |
| GP-FRCNN | 77.96 | 92.74 | 85.39 | 67.22 | 83.23 | 77.75 | 70.17 | 86.56 | 4 | — | — | — |
| SpotNet | 86.80 | 97.58 | 92.57 | 76.58 | 89.38 | 89.53 | 80.93 | 91.42 | 14 | 0.068 | 100.93 | 0.008 |
| SSD-VDIG | 82.68 | 94.60 | 89.71 | 70.65 | 89.81 | 83.02 | 73.35 | 88.11 | 2 | 0.092 | 41.28 | 0.020 |
| YOLOv5x | 86.89 | 95.96 | 90.17 | 79.89 | 90.67 | 84.86 | 83.42 | 90.92 | 9 | 0.2 | 31.255 | 0.026 |
| Yolov3 + FP | 85.29 | 96.04 | 89.42 | 76.55 | 88.00 | 88.67 | 78.90 | 88.91 | 9 | 0.395 | 15.975 | 0.050 |
| TKD | 51.29 | 54.48 | 53.65 | 48.47 | 62.79 | 41.87 | 50.91 | 47.69 | 47 | 0.79 | 8.53 | 0.060 |
| ARGOS | 83.53 | 93.16 | 86.34 | 76.71 | 90.71 | 78.45 | 77.64 | 90.6 | 25 | 1.8 | 3.44 | 0.22 |

Implementation: The system 100 executes at 16-bit precision, and experiments were performed on the workstation and embedded environment. Yolov5x was adapted as the teacher during experimentation. Image resolution was set to 864×864 at inference time. Bin-packing was used for applying the mask. The online knowledge distillation is executed on a separate thread; event detection and early detection are running concurrently to improve inference time. To have a fair comparison in the target device (Jetson Nano), the state-of-the-art methods were transferred to 16-bit precision and PyTorch.

Discussion: Table 3 compares the system 100 with different models evaluated on UA-DETRAC. The system 100 achieves the first rank among tested methods in terms of energy and accuracy score. Although extra steps were included such as event detection, experiments showed that the region removal procedure reduces the total execution time. The system 100 reduced the processing time by 80 ms, as the event detection and light detector run in parallel in CPU and GPU (Event detection: 80 ms, Backbone: 237 ms, Decoders: 8.5 ms). Experiments also showed that bin-packing and region-removal execution time are negligible compared to other modules (2.5 ms 8.5 ms). Thus, the system 100 could maintain accuracy while reducing the inference time in embedded devices.

The low performance of Spot-Net is observed in the embedded environment, which is due to the high memory requirements of this model (Although it was running on 16-bit precision). Due to limited memory space, FG-BR Net, HATS, and GP-FRCNN were not tested on the target device. The feature extractors in these works are expensive, although they have reduced the second stage processing. TKD (base on online knowledge distillation) has inferior performance due to the teacher's execution cost, which does not allow the system to be updated based on changes in the scene. This phenomenon shows the poor performance of methods that relies on the keyframe mechanism in a constrained system.

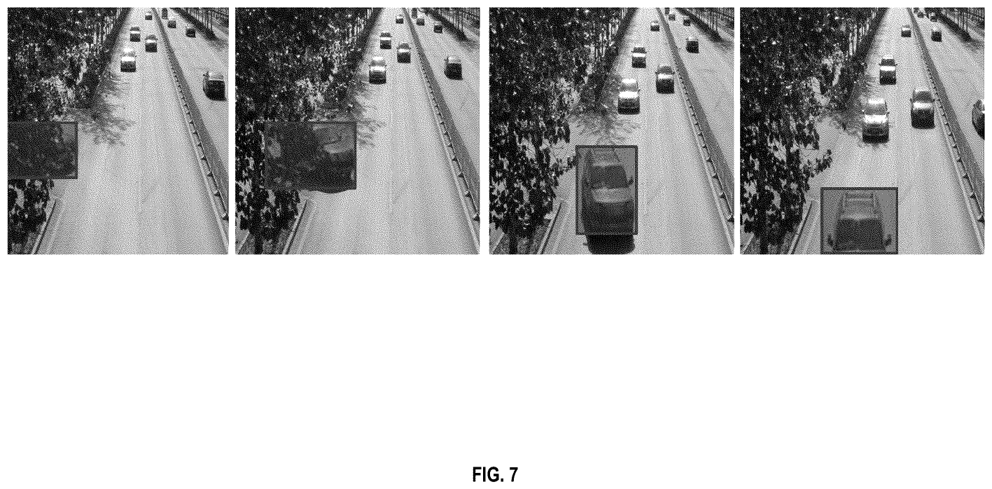

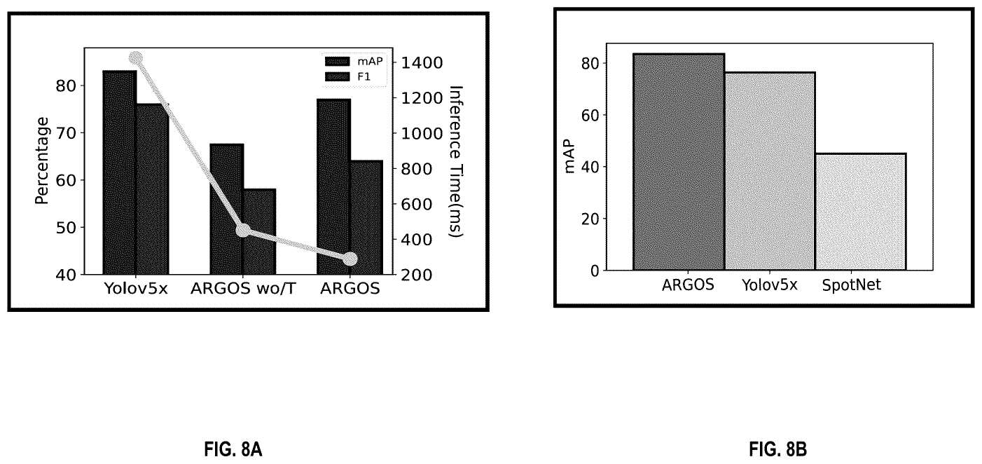

In real-world scenarios for vIM, the system 100 needs to know object types and their locations. Hence, there is a detection step and then a tracking step. If the system 100 detects an object, then the system 100 can start following the object with less computation. Considering this fact, experiments were conducted to understand what will happen if an object remains in the scene less than the object detector's execution time. FIG. 7 shows an example of this case where the camera (traffic camera) observed the marked car in less than 3 seconds. In this example, most of the proposed methods will miss the object. Another experiment was conducted to reevaluate proposed methods based on this fact. Here, objects were removed which are in the scene less than the inference time of each method and ran the evaluation on their results. Objects were removed using tracking information in the UA-DETRAC dataset. FIG. 8B shows the final results, which demonstrates the effectiveness of the system 100 in real-world scenarios.
4.3.2 WiseNet Dataset

To further validate the performance of the system 100 in fixed camera scenarios (for vIM), another experiment was conducted in indoor videos using the WiseNet dataset. Here, the benefit of early detection and online knowledge distillation are shown on system inference time and accuracy. The system 100 was compared with its Teacher (Yolov5x) and a modified version of the system 100 which lacked the online knowledge distillation and light detector module. All these configurations have been tested on the target embedded device in 16-bit precision at 512×512 resolution. FIG. 8A shows the Mean Average Precision (mAP) with IOU=0.5 and inference time of mentioned configurations. Although the system 100 has not reached its teacher accuracy; however, its inference time is 4.9×less than the teacher. Moreover, the accuracy of the modified version of the system 100 is less than the system 100 and its inference time is significantly more than the system 100, which shows the benefits of online knowledge distillation. The knowledge distilled from the deeper model to the light model (student) helps in reducing the number of requests to be processed by the teacher model.

### 5. Conclusion

This disclosure presents an approach for the decom-posing image into independent sub-regions and reducing the processing units. Although BNNs cannot reach state-of-the-art accuracy, experiments showed that these networks could significantly reduce the computation of DNNs while maintaining accuracy. Moreover, the system 100 can be extended to other methods to improve the processing speed while maintaining reasonably high accuracy, and at the same time, saves energy. Experiments on traffic camera videos (vIM application) showed 89% energy reduction and 4.9×faster inference speed. It shows the sparsity of objects in vIM compared to other applications in which objects are close to the camera (coco dataset). Furthermore, the experiments reveal the effectiveness of online training and its positive effect on efficiency. Finally, the promising experimental results suggest two potential future research avenues: 1) schedule the sub-process (Rols) in a heterogeneous environment; 2) distill knowledge to student model with partial information while processing other regions.

### 6. Methods

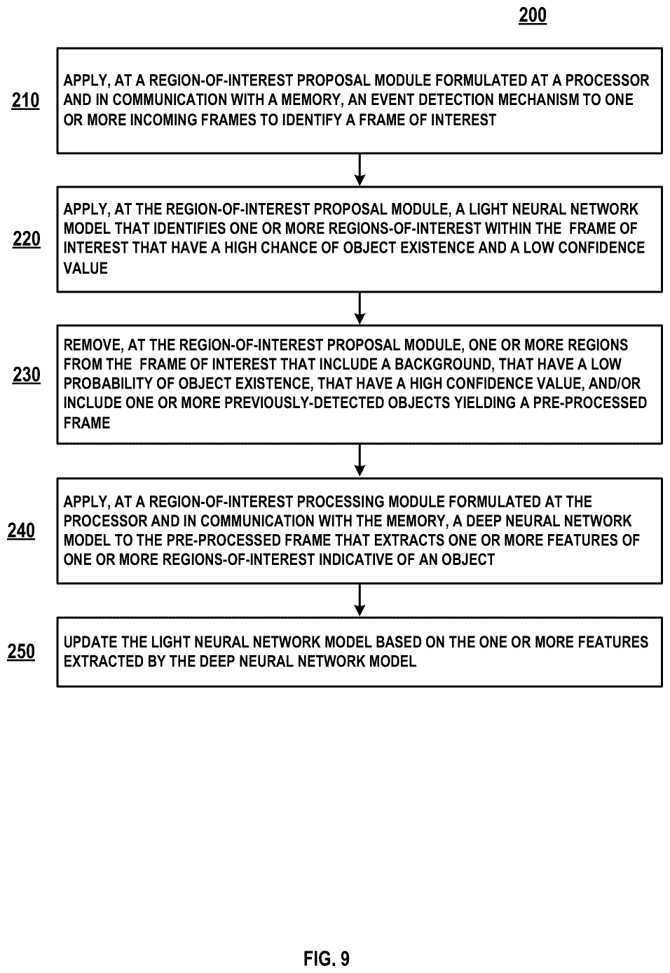

FIG. 9 illustrates a method 200 for object detection with reduced computational cost according to aspects of the present disclosure (e.g., system 100). Method 200 starts at block 210, which includes applying, at a region-of-interest proposal module formulated at a processor and in communication with a memory, an event detection mechanism to one or more incoming frames to identify a frame of interest. Block 220 includes applying, at the region-of-interest proposal module, a light neural network model that identifies one or more regions-of-interest within the frame of interest that have a high chance of object existence and a low confidence value. Block 230 includes removing, at the region-of-interest proposal module, one or more regions from the frame of interest that include a background, that have a low probability of object existence, that have a high confidence value, and/or include one or more previously-detected objects yielding a pre-processed frame. Block 240 includes applying, at a region-of-interest processing module formulated at the processor and in communication with the memory, a deep neural network model to pre-processed frame that extracts one or more features of one or more regions-of-interest indicative of an object. In some embodiments, for knowledge distillation, block 240 can be followed by block 250 which includes updating the light neural network model based on the one or more features extracted by the deep neural network model.

### 7. Computer-Implemented System

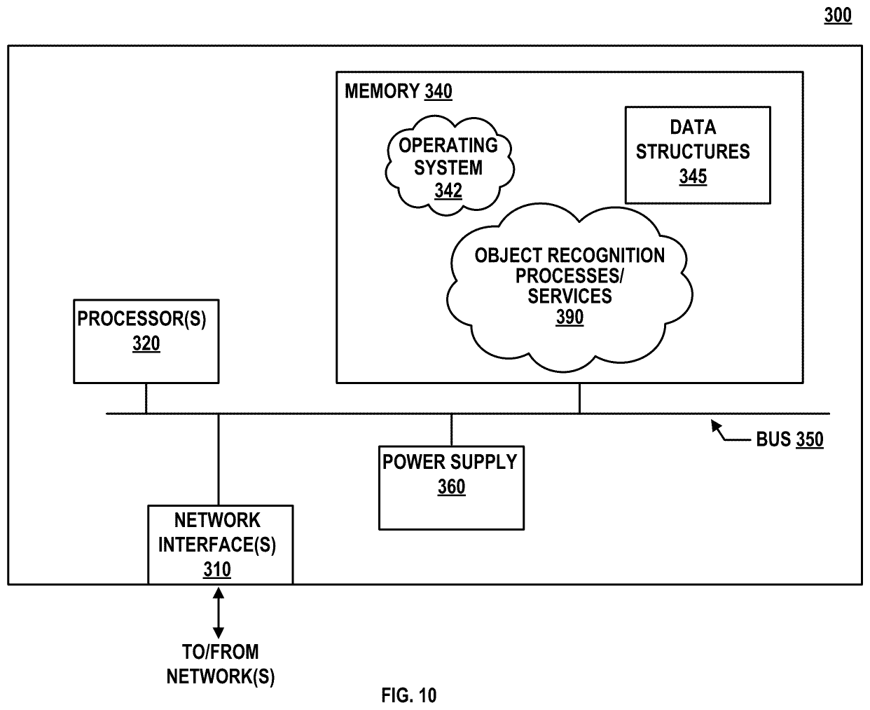

FIG. 10 is a schematic block diagram of an example device 300 that may be used with one or more embodiments described herein, e.g., as a component of system 100 and implementing aspects of method 200.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360. Network interfaces 310 can include or accommodate wireless (e.g., cellular) connections, long range radio connections, and can accommodate transmission of video across one or more networks or network connections.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches). Memory 340 can include instructions executable by the processor 320 that, when executed by the processor 320, cause the processor 320 to implement aspects of the system 100 and the method 200 outlined herein.

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include object recognition processes/services 390, which can include aspects of method 200 and/or implementations of various modules described herein. Note that while object recognition processes/services 390 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the object recognition processes/services 390 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for adaptive object recognition with reduced computational costs, comprising:
a processor in communication with a memory, the memory including instructions, which, when executed, cause the processor to:
access input frames including images associated with vehicular traffic generated by a camera; and
apply a first neural network to identify a plurality of regions of interest (ROls) in the input frames that satisfy a predetermined probability of object existence,
wherein the ROls accommodate implementation by a second neural network configured to focus on specific portions of the input frames associated with the ROls identified by the first neural network to reduce computational load for object recognition.

2. The system of claim 1, wherein the first neural network preprocesses the input frames by generation of the ROls to reduce an input size for the second neural network.

3. The system of claim 1, wherein the first neural network is configured to decompose the images of the input frames into sub-regions to accommodate application of a deep neural network to the ROls.

4. The system of claim 1, further comprising:
a power management assembly positioned proximate to the processor, the power management assembly including a battery in electrical communication with one or more solar panels that powers the processor to implement the first neural network and the second neural network.

5. The system of claim 1, wherein application of the first neural network reduces power consumption such that object detection by the processor applying the first neural network and the second neural network is powered solely by the battery and the one or more solar panels.

6. The system of claim 1, wherein the processor and the power management assembly are installed onto an existing traffic light pole or lamp post.

7. The system of claim 1, wherein the processor is configured for traffic data collection.

8. The system of claim 1, wherein the first neural network is a binary neural network defining different quantization structures to reduce computational load.

9. The system of claim 8, wherein a backbone of the binary neural network uses binary modules with final layers using binary weights and 4-bit activations.

10. The system of claim 8, wherein the binary neural network utilizes 1-bit weights and 8-bit activations in convolutional layers at an initial stage.

11. The system of claim 8, wherein the binary neural network generates a binary segmentation mask for single class segmentation to accommodate selection of the ROls for various objects and reduce computations by the second neural network by reducing the processing regions.

12. The system of claim 1, wherein the first neural network is a light detector of a knowledge distillation model configured for initial object detection and proposal of the ROls.

13. The system of claim 12, wherein as the light detector, the first neural network outputs objects with high confidence considered accurate detections and regions with low confidence considered low confidence, and the ROls are selected based on regions with the low confidence.

14. The system of claim 12, wherein the first neural network selects the ROls in which an event was observed.

15. The system of claim 12, wherein the input frames are decomposed to separate the ROls.

16. The system of claim 1, wherein the memory includes further instructions, which, when executed, cause the processor to execute a gather-scatter approach that gathers the ROls into a single dense matrix prior to application of convolution operations.

17. The system of claim 1, wherein the memory includes further instructions, which, when executed, cause the processor to implement bin-packing to put the regions (Rols) next to each other using a Maximal rectangles best short side fit approach to reduce execution time for packing.

18. The system of claim 1, wherein the memory includes further instructions, which, when executed, cause the processor to decompose the input frames into independent sub-regions to reduce computation time and energy consumption.

19. A method of adaptive object recognition with reduced computational costs, comprising:
accessing input frames including images associated with vehicular traffic generated by a camera; and
applying a first neural network to identify a plurality of regions of interest (ROls) in the input frames that satisfy a predetermined probability of object existence,
wherein the ROls accommodate implementation by a second neural network configured to focus on specific portions of the input frames associated with the ROls identified by the first neural network to reduce computational load for object recognition.

20. A non-transitory, computer-readable medium storing instructions encoded thereon, the instructions, when executed by one or more processors, cause the one or more processors to perform operations to:
access input frames including images associated with vehicular traffic; and
apply a first neural network to identify a plurality of regions of interest (ROls) in the input frames that satisfy a predetermined probability of object existence,
wherein the ROls accommodate implementation by a second neural network configured to focus on specific portions of the input frames associated with the ROls identified by the first neural network to reduce computational load for object recognition.
